(19) United States
(12) Patent Application Publication
(10) Pub. No.: US 2018/0096287 A1
(43) Pub. Date: Apr. 5, 2018

(54) RE-ROUTING A DELIVERY AGENT TO IMPROVE THE EFFICIENCY OF TRANSPORTING PACKAGES

(71) Applicant: Amazon Technologies, Inc., Seattle, WA (US)

(72) Inventor: Siddharth Singh Senger, Andhra Pradesh (IN)

(21) Appl. No.: 14/695,954

(22) Filed: Apr. 24, 2015

(51) Int. Cl. G06Q 10/08

(52) U.S. Cl. CPC G06Q 10/08; G06Q 10/08355

(57) ABSTRACT

A method that improves utilization of the full capacity of a delivery agent is disclosed. Initially the method may determine an arrival time for a delivery agent to arrive at a destination. The method may receive state data associated with the delivery agent where the state data comprises capacity data and location data for the delivery agent. The method may identify that an item is available for pick up from an additional location for delivery to the destination location. The method may calculate that the delivery agent has capacity for the item and that the delivery agent may pick up the item and still arrive at the destination location by the scheduled time. The method may update the first delivery route of the delivery agent to a second delivery route, where the second delivery route includes the additional location having the item available for pick up.

### BACKGROUND

Various warehouses may utilizes trucks and other vehicles or couriers to transport inventory between warehouses. The cost to transport inventory between warehouses may be a significant expense. Often vehicles will leave a facility partially full and arrive at its destination partially full. Accordingly, a destination may receive inventory from multiple trucks originating from multiple facilities. At various times, these facilities may be within short distances of each other.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components of features.

FIG. 1 illustrates an environment in which transportation resources for shipping packages may be optimized.

FIG. 2 illustrates an example of potential routes that may be suggested by a routing service.

FIG. 3 illustrates an electronic device that is configured to operate in an environment in which transportation resources for shipping packages may be optimized.

FIG. 4 illustrates a server configured to optimize shipping routes.

FIG. 5 is a flow diagram of an example system that may re-route a delivery agent to improve the efficiency of the transportation of packages.

FIG. 6 is a flow diagram of an example device that may communicate with the example system and receive an updated shipping route.

### DETAILED DESCRIPTION

Described herein are techniques and systems for re-routing a delivery agent to improve the efficiency of transporting packages. Using the techniques described herein, a delivery agent may be re-routed to pick up additional packages while in transit to a destination. As used herein, the term “delivery agent” may refer to people, vehicles such as trucks, trains, or cars, automated machines such as drones or robots, and the like. While a delivery agent is in transit to the destination, additional packages may be identified as being ready to be picked up from other locations for delivery to the destination. For instance, packages from warehouses located between the originating point of the delivery agent and the destination point of the delivery agent may be identified as having packages available to be delivered to the destination point or some other point in between.

In some examples, a state of the delivery agent is monitored as the delivery agent moves toward the destination. Generally, the state of the delivery agent may indicate whether the delivery agent is empty, full, or partially full and a location of the delivery agent. The state of the delivery agent may also include how many packages are on board, how much capacity is currently available on the delivery agent, the current schedule or route of the delivery agent, the expected or desired arrival time at the destination, as well as other information about the delivery agent.

In some configurations, a user may enter information about the state of the delivery agent through an interface. For example, a user may enter information about the state using an interface provided by a mobile application. This state data may be received by a routing service. In other examples, all or a portion of the state data associated with the state of the delivery agent may be generated without user input. For instance, a monitoring system may monitor the current capacity of the delivery agent and location, and provide this state data to the routing service (e.g., periodically or in response to an event).

As an illustrative example, assume that a delivery agent, such as a truck, is en route from facility A to destination C. After loading packages from facility A the truck driver may note that the truck is only partially full. As the delivery agent leaves the facility A, a user such as the truck driver may enter information about the truck's state into a mobile application which sends that information to a routing service. The truck's state may include information about how full the truck is. The mobile application may also send the location of the truck. After receiving the state data of the truck, the routing service may determine if there is time for the truck to pick up additional packages from other locations and still arrive at destination C on time.

In some examples, the routing service determines facilities located within some distance of the truck that may have packages available for delivery to facility C. The distance may be selected based on a maximum distance that the truck can travel off its current route and still reach the destination as scheduled. According to some configurations, the routing service may query these facilities to determine whether packages are ready for pick-up and delivery to facility C. After determining the facilities that have packages available for pick-up, the routing service may generate a graph of route suggestions including stops at locations that are within a distance r of the truck that have packages intended for destination C. The routing service may suggest changes to the current truck route based on the graph such that the truck is able to pick up from additional facilities between A and destination C and still arrive on time at destination C.

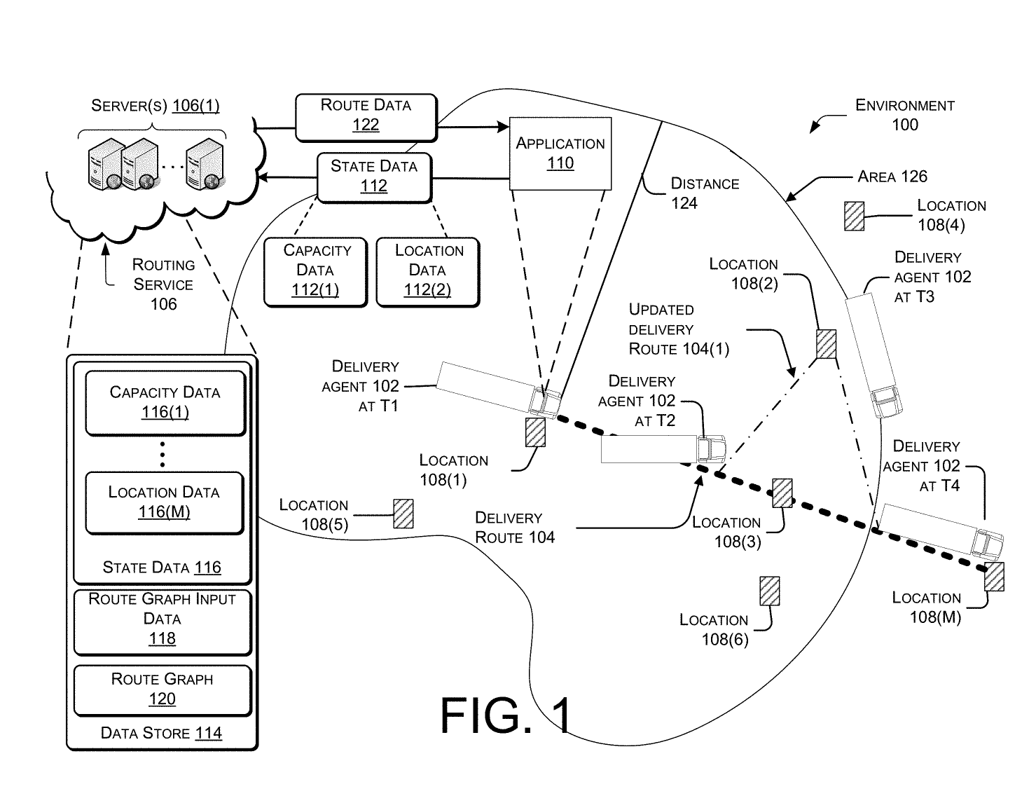

The routing service may track the state of the truck as it is in transit as well as the status of packages that need to be shipped from facilities located between A and C. For example, if the routing service determines that packages are ready to leave facility B as the truck is en route to facility C, the routing service may re-route the truck to pick up packages from facility B and deliver them to facility C. Additional details regarding the various techniques, systems and processes described above relating to re-routing a delivery agent to improve the efficiency of transporting packages will be presented below with regard to FIGS. 1-6.

FIG. 1 illustrates an environment 100 in which a delivery agent 102 may be re-routed from an initial delivery route 104 in response to receiving a notification from routing service 106. A delivery agent may utilize any mode of transportation to move one or more packages, items, and/or inventory, from one location to another. For example, a delivery agent may comprise various vehicles utilized to move packages such as a truck, plane, drone, and the like. A delivery agent may also comprise a person such as a courier utilizing any form of transportation to move the packages, such as walking, riding a bike, riding a motorcycle, riding a horse, using a scooter or skateboard, using public transportation, or driving a car or any other known vehicle.

Initially the delivery agent 102 may be assigned delivery route 104 that starts at location 108(1) and ends at location 108(M). In the current example illustrated in FIG. 1, the locations 108(1) . . . 108(M), which may be referred to herein as “locations,” represent the locations to which or from which a package may be moved. The locations may represent pick-up locations, such as facilities and warehouses that store various packages for delivery, sort centers, locker-based pickup points, or pick-up points chosen by individuals. For instance, the locations may also comprise private residences or offices containing packages that need to be delivered elsewhere. The locations may also represent a destination point such as a residence or workplace of a recipient of a package. Although four locations are shown in FIG. 1 for discussion purposes, more or fewer locations may be located within the area 126 of the delivery route 104. Additionally, the distance between each of the locations may vary by several miles to hundreds of miles. Similarly, the delivery route 104 may span several regions or states (or farther) or a few city blocks.

In the example illustrated in FIG. 1, the delivery agent 102 at time T1 may be loaded with containers from location 108(1). A container may be a package or contain many packages or boxes. In this example, the delivery agent 102 may be a truck with a capacity to carry a certain number of containers. After loading the delivery agent 102 with the containers, a driver or operator of the delivery agent 102 may update the routing service 106 of the current state of the delivery agent 102 via application 110. In various examples, the state of the delivery agent 102 may comprise information about the location of the delivery agent 102, a size or capacity of the delivery agent 102, the speed of the delivery agent 102, an arrival time at a destination, and the like. For example, the state data 112 may comprise capacity data 112(1) and location data 112(2).

As illustrated, the application 110 provides state data 112 to the routing service 106. Although in this example, the delivery agent 102 may have a driver, in other examples, an operator may comprise a machine or any person remotely or directly controlling the delivery agent 102. In some examples, capacity data may be provided by some other entity other than the operator of the delivery agent 102. For example, an associate who is associated with the routing service 106 or with the location 108(1) may provide this data.

In some examples, the delivery agent 102 may be configured to provide state data without human or user interaction. For example, the delivery agent 102 may include sensors (not shown), such as weight sensors, imaging devices, scanning devices, GPS, or other location determining devices, that may assess information corresponding to a state of the delivery agent (e.g., a truck). These sensors may detect that a delivery agent 102 has been loaded, a remaining capacity of the delivery agent 102, and a location of the delivery agent 102. In some configurations, the delivery agent 102 or the routing service 106 may determine remaining capacity of the delivery agent 102 based on the packages and/or containers loaded on the delivery agent 102. For example, the delivery agent 102 or the routing service 106 may reference a database (or some other information source) to determine a size and weight of the items already loaded to determine how much remaining capacity is available. Thus, in various examples, the state of the delivery agent 102 may be built automatically by the routing service 106, without requiring additional input from a human being, such as a driver, of the delivery agent 102.

In one example, the routing service 106 may schedule a delivery agent 102 to drive a particular route, such as delivery route 104. The routing service 106 may obtain information corresponding to a size of truck. As the delivery agent 102 unloads and loads packages, various sensors present either on the delivery agent 102 or a device of an operator of the delivery agent 102 may detect packages as they are unloaded or loaded or changes in the weight of the delivery agent 102. Based on this detected data collected via the sensors, the routing service 106 may then ascertain a remaining capacity of the delivery agent 102. This information may be used to build the state of the delivery agent 102.

According to some configurations, the driver of the delivery agent 102 may access the application 110 through a mobile device or any device capable of running the application 110. In an example, the application 110 may be accessed through a web user interface. In various examples, the application 110 may comprise one or more programs designed to carry out operations for communicating with the routing service 106 as well as collecting relevant data from an operator of the delivery agent 102. The device capable of running the application 110 may be any number of computing or electronic devices, such as a mobile phone, computer, laptop computer, tablet, a reader device, a navigation system, a media playing device, a portable gaming device, a netbook computing device, a wearable computing device (e.g., watch, glasses), and so on.

In this example, the operator of the delivery agent 102 may enter information into an interface provided by the application 110 corresponding to a capacity of the delivery agent 102. The information corresponding to the capacity of the delivery agent 102 may include data about the remaining capacity of the delivery agent 102. For example, in the case where the delivery agent 102 has a capacity for 15 containers and 10 containers were loaded into the delivery agent, the operator of the delivery agent 102 may indicate that the delivery agent 102 has capacity to carry 5 more containers. In other examples, the operator may enter information about how full the delivery agent 102 is after loading instead of the remaining capacity of the delivery agent 102. In various implementations, capacity data 112(1) may comprise this information corresponding to the capacity of the delivery agent 102.

The application 110, or some other component, may also determine a location of the delivery agent 102. For example, a GPS system attached to the device, or otherwise located on or near the delivery agent 102 may be utilized by the application 110. In other instances, the operator of the delivery agent 102 may simply enter in the name of the facility or a known address of the facility, from which the routing service 106 extracts location data to determine the coordinates of the delivery agent 102's location. This data may be sent to the routing service 106 as location data 112(2). In other examples, the application 110 transmits delivery agent location data 112(2) periodically as the delivery agent 102 travels through delivery route 104. Accordingly, in various examples, the state of the delivery agent 102 may comprise information about the location of the delivery agent 102, a size or capacity of the delivery agent 102, the speed of the delivery agent 102, an arrival time at a destination, and the like.

The application 110 may send the state data 112 comprising the capacity data 112(1) and the location data 112(2) to the routing service 106. The routing service 106 may comprise one or more servers 106(1). In such implementations, the servers 106(1) may be in communication with the device running the application 110 via a wireless network. In the case of wireless networks, the device comprising application 110 may utilize wireless networks such as wide area networks (e.g., cellular network) or a local area network (e.g., a Wi-Fi network), or the like.

In several examples, an operator of the delivery agent 102 (e.g., the driver of a truck) may initially stop at location 108(1) and begin loading containers into the delivery agent 102. After loading the delivery agent 102, the operator may access application 110 and indicate that the loading of the truck has been completed. Upon receipt of the indication that the loading of the delivery agent 102 has been completed, the application 110 may receive or determine the location of the delivery agent 102.

The application 110 may send the location of the delivery agent 102 to the routing service 106 as location data 112(2). Next, the application 110 may prompt the operator of the delivery agent 102 for additional input such as whether the delivery agent 102 is full or an expected number of additional containers that could fit in the delivery agent 102. In other examples, the available capacity of the delivery agent 102 may have already been provided to the routing service 106.

After receiving the state data 112 of the delivery agent 102 from application 110, the routing service 106 may proceed with determining an area, such as area 126, within which to query additional facilities to determine whether containers may be picked up by delivery agent 102 as delivery agent 102 travels to location 108(M). In various examples, area 126 represents an area within which the delivery agent 102 may travel from its current delivery route and still arrive at a destination by a scheduled arrival time. At any given time, area 126 is an area surrounding the delivery agent 102. Accordingly, an area 126 may include all locations which routing service 104 may query. In various implementations, the area 126 may be determined using various factors such as the mode of transportation of the delivery agent 102 (ground-based vehicles, walking, flying vehicles), traffic patterns, the geography of the surrounding area, a size of the delivery agent 102, remaining capacity of the delivery agent 102, the arrival time of the delivery agent 102 at its destination, and the like.

In one example, the routing service 106 may initially determine a distance 124 that correlates to a maximum distance within which the delivery agent 102 may deviate from its original course in a particular direction and still arrive at a destination by a scheduled arrival time. In various examples, the distance 124 may be determined to prevent an overcomputation of data. For example, without defining a distance 124 within which to query locations, the routing service 106 may allocate resources to compute data for a large number of locations that contain several hundreds to millions of containers. By limiting the number of locations that are queried by the routing service 106, to those locations that fall within a distance 124, the routing service 106 may avoid analyzing a large amount of data that is not needed. For example, if the delivery agent 102 does not have time to stop at a location and arrive at a destination location 108(M) by a scheduled arrival time, there is no need to include the location in an analysis performed by the routing service 106 for the particular delivery agent 102.

In several examples, the value of distance 124 may vary in different sectors of area 126. For example, in one instance, the delivery agent 102 may travel a greater distance in one direction because traffic is light and the delivery agent 102 may travel on a highway to get to an additional location. In another sector of area 126, the delivery agent 102 may travel only a smaller distance away from an original route because the route to the additional location goes through a heavily congested area. Additionally, area 126 may change as the delivery agent 102 is in transit.

In some examples, the routing service 106 may determine a speed of the delivery agent 102 based on the location data 112(2) that the routing service 106 receives from application 110 over time. For example, location data 112(2) may be received periodically, in response to an event, or based on some other criteria. In some examples where location data 112(2) is received periodically, the duration of the interval may depend on the type of vehicle comprising the delivery agent 102 or the geography within which the delivery agent 102 is traveling. In various implementations, the routing service 106 may determine a scheduled arrival time by accessing information in a data store tracking various scheduled delivery routes. In some implementations, the operator of the delivery agent 102 may provide this information. Parameters corresponding to the scheduled arrival time, speed of the delivery agent 102, traffic, and the like may all be assessed to define area 126 at any given time.

In FIG. 1, the routing service 106 may receive state data 112 at time T1 after an operator of the delivery agent 102 confirms that the inventory has been loaded on the delivery agent 102. In various implementations, the routing service 106 may store state data 112, as state data 116, in a data store 114. In various examples, capacity data 116(1) may correspond to capacity data 112(1) and location data 116(M) may correspond to location data 112(2). In various examples, the routing service 106 may receive the state data 112 while the delivery agent 102 is en route, that is, after the delivery agent 102 has left location 108(1) at the start of delivery route 104.

The routing service 106 may use the state data 116, as well as various other parameters discussed previously to determine an area within which to query locations that are not currently on the scheduled route for delivery agent 102. As delivery agent 102 traverses along a scheduled route, the area 126 may change based on changes in the various parameters. For example, as the delivery agent 102 approaches its final destination location 108(M) at time T4, the area 126 may be smaller than area 126 at time T1. This may occur because the delivery agent 102 has less flexibility (e.g., time) to deviate from its current route to pick up additional containers without arriving late at the location 108(M).

In an example, after delivery agent 102 picks up 10 containers from location 108(1), it may send state data 112 to the routing service 106. For instance the state data 112 may comprise capacity data 112(1) indicating that delivery agent 102 has completed loading the 10 containers or that delivery agent 102 has the capacity to load five more containers. Using the capacity data 112(1), the routing service 106 may determine that delivery agent 102 is not full and additionally that the delivery agent 102 needs to arrive at location 108(M) in five hours. The routing service 106 may proceed to create a route graph. In order to create the route graph, the routing service 106 may determine a distance such as distance 124 within which a delivery agent 102 may travel to and still arrive at location 108(M) within five hours.

The routing service 106 may utilize various algorithms including online algorithms that can process inputs serially. In various examples, these online algorithms do not require that all inputs are available and received at the time the algorithm begins running. Thus the routing service 106 may receive inputs at different times while an online algorithm is running and still generate the route graph 120 with incomplete data.

In several examples, the routing service 106 may generate the route graph 120 in response to receiving the state data 112, a portion of the state data 112 (e.g., receiving capacity data 112(1) or location data 112(2)), receiving an on-demand request from application 110, or based on some other criteria. In several examples, this route graph 120 is generated while the delivery agent 102 is en route. Thus, instead of providing a static route scheduling service, which may be determined prior to when a delivery agent 102 begins a scheduled route, the routing service 106 provides a service that dynamically updates scheduling routes while the delivery agent 102 is traveling along a delivery route. In several examples, the routing service 106 may process inputs in a serial fashion without requiring that all inputs be available initially when creating the route graph 120. In other words, the route graph 120 may be created based on available inputs at any given time. For example, as a delivery agent 102 travels from one location 108 to another, the area 126 may change. As area 126 changes, the locations 108 included within the area 126 will also change.

When a change in area 126 results in an inclusion of an additional location 108, the route graph 120 may be updated by the routing service 106 to include this additional location 108. In various examples, the route graph 120 may be updated to include information correlating to the additional location without regenerating all of route graph 120. That is, when a change in area 126 results in the inclusion of an additional location, the routing service 106 may not need to recalculate data corresponding to locations already included in the route graph 120.

In several examples, the routing service 106 may query locations within a vicinity, e.g., within the distance 124 and/or within the area 126, of the delivery agent 102 as the delivery agent 102 travels along a delivery route. In these examples, by querying the locations within a vicinity of the delivery agent 102, the routing service 106 may obtain the most current information about the status of packages that are ready for delivery. In several examples, these packages may not be ready during time T1, but at some time later when the delivery agent 102 is en route. As locations enter into the vicinity of the delivery agent 102, the routing service 106 may determine whether the delivery agent 102 has time to pick up additional packages from these locations and still arrive by a scheduled arrival time at the delivery location.

In one example, the vicinity of the delivery agent 102 may be defined by area 126. Area 126 may change from when the delivery agent 102 is on delivery route 104 at time T1 to when the delivery agent 102 is on delivery route 104 at time T2. As depicted, area 126 correlates to an area when delivery agent 102 is located at location 108(1) at time T1. At time T2, the area 126 may change and include additional locations, such as location 108(4). At time T2 the area 126 may no longer include location 108(5). Accordingly, the route graph 120 may be updated as locations are added or removed as the delivery agent is en route.

In FIG. 1, locations 108(1)-108(3), 108(5) and 108(6) fall within area 126. In one example, the routing service 106 may query locations 108 within area 126 that are currently not designated stops for the delivery agent 102 to determine whether these locations have any containers scheduled for the same destination as location 108(M) or are scheduled on a route that includes a drop off at location 108(M). In other examples, locations 108 may request the routing service 106 to pick up packages that are ready for delivery. For several of the containers delivered to location 108(M), location 108(M) might be a final destination at which these packages may be consumed. In other cases, location 108(M) may be a transit location from which the packages continue to a different drop off location or final destination.

In several other examples, additional packages or containers may be both picked up and dropped off at additional locations along a scheduled delivery route. An updated route may include reroutes for the delivery agent 102 such that it picks up a package at a location not originally part of an initial delivery route and drops off the package at a drop off location that is also not originally part of the initial delivery route. Any combination of adding on drop off and pick up locations is possible as long as the delivery agent 102 is still able to arrive at an originally scheduled destination location by a scheduled arrival time. In this manner, the routing service 106 may help improve the efficiency of transporting packages.

This scheduling data received by the routing service 106 may be stored as route graph input data 118. In some examples, the scheduling data may include route information for the delivery route 104 such as a list of locations at which the delivery agent 102 is scheduled to load and unload. The routing service 106 may determine package data including a number of containers, the location of the containers, the size of the containers, a scheduled arrival time for the containers, and the like, and store this information as route graph input data 118. Additionally, route graph input data 118 may include some inputs such as locations 108(2) and 108(3) that may be used to generate a route graph. In additional examples, the route graph input data 118 may include data about the delivery agent 102 such as the type or capacity model associated with the delivery agent 102.

Using the state data 116 and the route graph input data 118, the routing service 106 may generate the route graph 120 or map including suggestions for different routes the delivery agent 102 could take to pick up additional packages on the way to location 108(M). To generate the route graph 120, the routing service 106 may look for unscheduled packages that could fit into the delivery agent 102. This route graph 120 may be stored within the data store 114. In the current example, the routing service 106 may determine that location 108(2) has some containers that are scheduled to be delivered to location 108(M). Accordingly, the routing service 106 may include updated delivery route 104(1) as one route option in the route graph stored as route graph 120.

An updated delivery route does not necessarily require that a delivery agent 102's original route be altered. For example, an update to the route may comprise making an additional stop at a location that is already present along the original delivery route but where the additional stop was not originally on the route as a pick up/drop off location. For example, an original delivery route 104 for the delivery agent 102 may include a stop at location 108(1) and a stop at location 108(M) with no other stops in between. An update to the original delivery route 104 may include instructions to the delivery agent 102 to make an additional stop at location 108(3) situated along the original delivery route 104. In several examples, the routing service 106 may present the route graph 120 to a deciding entity such as an associate for further processing. For example, the routing service 106 may present the one or more updated delivery routes to an associate who may then choose one of the routes and instruct the delivery agent 102 to follow the chosen route. The chosen route may be sent to the application 110 as route data 122.

In several examples, an associate may comprise an individual who receives route graph 120 on a device, such as a computer. In various examples, the deciding entity may also comprise a separate module within the routing system 106 that chooses one of the updated delivery routes and instructs the delivery agent 102 to follow the chosen updated delivery route.

In other examples, the routing service 106 may present the one or more updated delivery routes to a program or application that may be used by individuals who are interested in utilizing unused capacity in the delivery agent 102. In one example, the program may present an online bidding portal to individual customers who may bid for available capacity on a delivery agent 102. The program may present a user interface to an interested individual and prompt the individual for input corresponding to the number of packages the individual would like to ship, pick up and drop off locations, or other criteria and populate a route graph depicting options for delivery agents along with details such as pickup and drop off locations associated with each delivery agent, an initial bidding price for available capacity, expected pickup and delivery time windows, and the like.

As depicted in FIG. 1, in one example, the routing service 106 may determine that location 108(2) has containers that need to be delivered to location 108(M). The routing service 106 may determine that based at least partly on a speed of the delivery agent 102, the updated delivery route 104(1) would add an hour of transit time for the delivery agent 102 to pick up containers from location 108(2). If the delivery agent 102 needs to arrive at location 108(M) in five hours after departing at time T1, the routing service 106 may suggest the updated delivery route 104(1) after determining that traversing this updated delivery route 104(1) will not result in the delivery agent 102 arriving at location 108(M) after a scheduled arrival time. For example, this may occur if the routing service 106 determines that it will take the delivery agent 102 three hours to traverse the original delivery route 104 from location 108(1) to 108(M). Thus, if the delivery agent 102 needs to arrive at location 108(M) in five hours after departing at time T1, the delivery agent 102 may still arrive at location 108(M) before a scheduled arrival time even after an additional hour is added to the route. Accordingly, the routing service 106 may include the updated delivery route 104(1) in the route graph 120.

The routing service 106 may present the route graph 120 to a deciding entity such as an associate who may then choose to instruct the delivery agent 102 at time T2 to take the updated delivery route 104(1). The instructions to take the updated delivery route 104(1) may be sent to the application 110 as route data 122. Accordingly, the delivery agent 102 may proceed along the updated delivery route 104(1) at time T2 and arrive at location 108(2) at time T3.

At time T3, an operator of the delivery agent 102 may send capacity data 112(1) with information about the number of containers that are loaded on delivery agent 102. Application 110 may also send location data 112(2) in accordance with techniques described above. After receiving this information, the routing service 106 may recalculate an area 126 and determine whether to suggest additional stops or route changes prior to the delivery agent 102 arriving at location 108(M). At time T4, the delivery agent 102 arrives at location 108(M) before or during its scheduled arrival time.

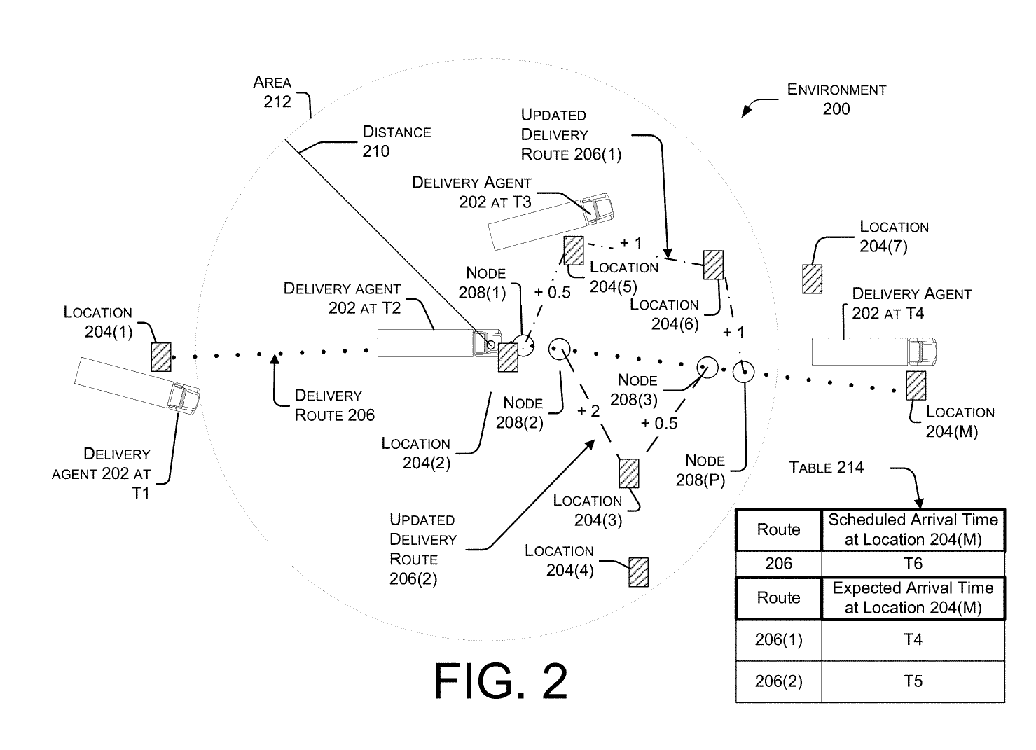

FIG. 2 depicts an environment 200 in which potential routes may be suggested by the routing service 106 and included in a route graph. The delivery agent 202 may load packages from location 204(1) during time T1 and begin traveling along an initially scheduled delivery route 206. The delivery route 206 begins at location 204(1) and ends at location 204(M) with one scheduled stop at location 204(2). Similar to locations 108(1)-108(M) as discussed with regards to FIG. 1, locations 204(1)-204(M) may represent pick-up or drop-off locations, such as facilities and warehouses. The locations may also comprise private residences or offices containing packages that need to be delivered elsewhere. These locations 204(1)-204(M) may also represent a residence or workplace of a recipient of a package. Although eight locations are shown for discussion purposes, more or fewer locations may be located within the area of the delivery route 206. Additionally, similar to the distance between the locations in FIG. 1, locations 204(1)-204(M) may be several miles to hundreds of miles apart. Accordingly, the delivery route 204 may span several regions or states or a few city blocks.

During a time close to time T1, the delivery agent 202 may send capacity data 112(1) including information about capacity left on the delivery agent 202 or the number of containers loaded on the delivery agent 202 as well as location data 112(2) of the delivery agent 202. At time T2, the delivery agent 202 may receive a notification in the form of route data 122 directing the delivery agent 202 to traverse an updated delivery route 206(1) instead of the initially scheduled delivery route 206.

As depicted, updated delivery route 206(1) comprises two additional locations 204(5) and 204(6). As discussed previously, this notification may come from the routing service 106 or an associate tied to the routing service 106. In response to receiving this notification of route data 122, the delivery agent 202 may change its route to the updated delivery route 206(1) and arrive at location 204(5) at time T3. The delivery agent 202 may then proceed to location 204(6) and arrive at location 204(M) at T4. In this example, the location 204(M) may be a final destination location comprising another facility or a location of a recipient of packages delivered by delivery agent 202.

As discussed previously, the routing service 106 may assess various factors to optimize transportation efficiency for various packages located at the locations 204(1)-204(M). For example, when delivery agent 202 leaves location 204(1) at time T1 and submits capacity data 112(1) to the routing service 106, the routing service 106 may initially determine an area 212 within which to query locations and determine whether to suggest any route updates. As also discussed previously, the size and shape of area 212 may change based on various parameters, such as a scheduled arrival time, speed of the delivery agent 202, traffic, and the like.

As depicted in FIG. 2, area 212 represents an area as calculated concurrent to or substantially simultaneous to time T2. In several examples, the routing service 106 may continually, periodically, or at other designated times, calculate area 212. Thus, in some examples, the area 212 may change even when a delivery agent 202 is stopped as the expected arrival time draws closer. This is due to the fact that the distance that the delivery agent 202 is able to digress from a current route decreases as an expected arrival time approaches.

At time T2, the delivery agent 202 may arrive at location 204(2) as scheduled according to the initially scheduled delivery route 206. After loading/unloading containers, an operator of the delivery agent 202 may send additional capacity data 112(1) to the routing service 106 indicating the number of containers on the delivery agent 202 and/or remaining capacity of the delivery agent 202. As discussed previously, the application 110 may also send location data 112(2) of the delivery agent 202. Based on the received state data 112, at time T2, the routing service 106 may determine an area 212 representing an area within which the delivery agent 202 may deviate from the delivery route 206 and still arrive at destination 204(M) by its scheduled arrival time. In this case, as depicted in table 214, the delivery agent 202 is initially scheduled to arrive by time T6 at location 204(M) on route 206.

In various examples, after receiving capacity data 112(1) at time T2, the routing service 106 may request data from locations within area 212, such as locations 204(3), 204(4), 204(5), and 204(6) and determine whether any of these locations have containers that need to be transported to location 204(M). As discussed previously, these locations may also request the routing service 106 to pick up packages that are ready for delivery. In one example, locations 204(3), 204(5), and 204(6) all contain packages that need to be transported to location 204(M).

Next, the routing service 106 may create a route graph that includes various routes the delivery agent 202 may take to pick up additional containers. The routing service 106 may determine additional time that each route might add on to a route of delivery agent 202 and propose suggested routes that place the delivery agent 202 at the final destination location 204(M) at or before the scheduled arrival time. For example, the routing service 106 may determine that an additional transit time of 2.5 hours would be added on to the route of delivery agent 202 if the delivery agent 202 were to traverse the updated delivery route 206(1). This is depicted in FIG. 2 by the +0.5, representing 0.5 hour of travel time from node 208(1) to location 204(5), the +1, representing 1 hour of travel time from location 204(5) to location 204(6) and the +1, representing 1 hour of travel time from location 204(6) to node 208(P). The routing service 106 may determine that this additional 2.5 hours would place the delivery agent 202 at location 204(M) at time T4. As long as time T4 is equal to or less than time T6, the routing service 106 may include this route in the route graph 120.

For individual containers that the routing service 106 determines need to be picked up, in various examples, the routing service 106 may calculate whether the delivery agent 202 has the capacity to pick up the additional container. Additionally, in various examples, the routing service 106 may also calculate that the delivery agent has the time to pick up the item and still arrive at the destination location 204(M) by the scheduled arrival time. Once the routing service 106 determines that the delivery agent 202 has the capacity and time to pick up an additional container, it may include an updated route including picking up the additional container in the route graph 120.

Accordingly, in FIG. 2, the routing service 106 may suggest updated delivery route 206(1) and updated delivery route 206(2) to a deciding entity, such as an associate working with the routing service 106. In several examples, delivery route 206(2) may include an additional pick up location at 204(3). As depicted in table 214, if a delivery agent 202 travels along updated delivery route 206(2), the routing service 106 may calculate an expected arrival time of time T5 at location 204(M). Although two updated delivery routes 206(1) and 206(2) are depicted in FIG. 2, any number of updated routes may be presented to an associate. As discussed previously, instead of presenting optional routes to an associate, a module in the routing service 106 may also determine which particular route to direct the delivery agent 202 to take.

As discussed previously, the routing service 106 may generate the route graph 120. As area 212 changes, due to a change in location or size and shape of area 212, the locations within area 212 may change. As the locations within area 212 change, the route graph 120 may be updated accordingly. As discussed previously, available locations may change as the truck traverses delivery route 206. As the delivery agent 202 traverses from location 204(1) to 204(2), for example, the area 212 will change. As a result, location 204(5) may fall within area 212 before location 204(6) does. Additionally, as the delivery agent 202 traverses along a scheduled delivery route 206, the locations included within area 212 will change due to changes in the location or capacity of the delivery agent 202, among other factors. For example, the locations present within area 212 at time T2 include the locations 204(2)-204(6). At time T3, area 212 may also include location 204(7) and no longer include location 204(4), for example. In several examples, time T3 occurs before time T4, the expected arrival time of the delivery agent 202 at location 204(M).

In various examples, the route graph 120 may be adjusted as locations are added in progression as well as removed. In one example, the routing service 106 used to generate the route graph 120 may detect the addition of a location and determine information corresponding to each location that is included within area 212. The routing service 106 used to generate the route graph 120 may determine whether the additional location has containers that need to be transported to location 204(M), an arrival time for the containers, and the like. Additionally, the routing service 106 may also determine additional time that a delivery agent 202 may need to stop at the additional location.

In various examples, the routing service 106 may update the route graph 120 to include an additional location without recalculating data associated with locations already included in the route graph 120. That is, as changes occur to the locations included within an area 212 due to a change in the size of the area 212 or the location of area 212, the routing service 106 may not recalculate the various data to regenerate route graph 120. Instead, as locations are included within an area or fall outside of area 212, the routing service 106 may calculate data corresponding only to these particular locations and adjust the route graph 120 accordingly. In one example, the routing service 106 may collect data and determine information about a location a single time and refrain from querying this location again during a subsequent generation of the route graph 120.

Additionally, the route graph 120 may also propose nodes 208(1), 208(2), and 208(3) as points of merging for different routes. Thus, as the routing service 106 generates a route graph 120, the routing service 106 is not confined to just the locations 204(1)-204(M) as potential nodes in the route graph. The mechanisms may also introduce additional nodes which do not represent physical locations where containers are located but rather a point where the delivery agent 202 may converge on to a different delivery route. For example, node 208(1) represents a point at which delivery agent 202 may change routes from delivery route 206 to updated delivery route 206(1).

In an example in which an associate chooses a route, the associate may choose one of the two routes 206(1) and 206(2) and present the chosen route to the delivery agent 202 sometime near or after time T2. In various implementations, this chosen route may be communicated to an operator of the delivery agent 202 as route data 122 through a push notification that appears on a device of the operator of the delivery agent 202.

By utilizing a delivery agent 202 that is partially full to transport these packages to location 204(M), the efficiency and utilization of the transportation resources to transport these packages may be improved. For example, by using one delivery agent 202 that is already in transit to transport multiple packages from locations 204(1), 204(2), 204(5), and 204(6) instead of multiple delivery agents that are each assigned to a single location and that may be partially full, efficiency and utilization of the transportation resources may be improved. For example, without a push notification from the routing service 106 that updates the route of delivery agent 202 from the delivery route 206 to the updated delivery route 206(1) while en route to the location 204(M), at least one additional delivery agent would have to be used to transport containers from locations 204(5) and 204(6) to location 204(M), since these locations were not originally included in the delivery route 206. By eliminating the use of additional delivery agents to transport packages from locations 204(5) and 204(6), efficiency and utilization of transportation resources may be optimized.

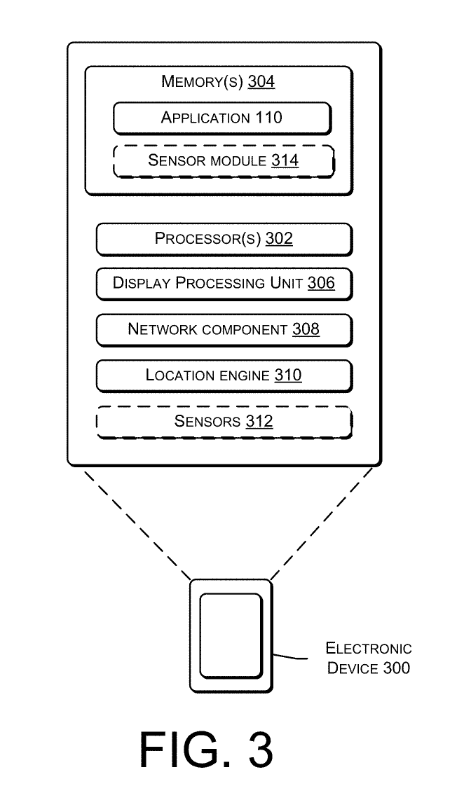

FIG. 3 illustrates an electronic device 300 configured to interact with the routing service 106. In several examples, the electronic device 300 may include one or more processors 302, a display processing unit 306, a network component 308, a navigation component or location engine 310, sensors 312, and one or more memory devices 304.

The one or more processors 302 may include at least one hardware processor, such as a microprocessor. In some cases, the one or more processors 302 may include a central processing unit (CPU), a graphics processing unit (GPU), or both a CPU and GPU, or other processing units. Additionally, the one or more processors 302 may include a local memory that may store program modules, program data, and/or portions of one or more operating systems. In an illustrative example, the one or more processors 302 may also include a cache memory and one or more registers as well as digital electronic circuits such as an arithmetic logic unit (ALU) and a control unit. Additionally, the electronic device 300 may include a display processing unit 306 that may comprise a specialized electronic circuit designed to accelerate the creation of images in a frame buffer intended for output to a display. The display processing unit 306 may process large blocks of data in parallel.

In some instances, network component 308 may coordinate the exchange of data packets in the form of signals via a wireless local area network. In other implementations, this exchange of data packets may occur via a wireless wide area network. Network component 308 may utilize one or more antennas to exchange the data packets or communicate signals over the wireless network. For example, network component 308 may utilize the one or more antennas to communicate signals via a wireless local area network. In other examples, the network component 308 may exchange data packets via Bluetooth and/or Near Field Communication (NFC) technologies. In another example, the network component 308 may utilize the one or more antennas to communicate signals via a wireless wide area network.

In several examples, the location engine 310 may have the capability to detect the location of the electronic device 300 on the surface of the earth. The location engine 310 may communicate with one or more satellites orbiting the earth via an antenna that is tuned to the frequencies transmitted by the one or more satellites. In several examples, location engine 310 may determine a location of the electronic device 310 in terms of coordinates and also determine an accuracy of the determined coordinates. For instance, in the case where the electronic device 300 is moving along on a freeway, the accuracy may indicate that the determined coordinates are accurate to a few meters. In another example, when the electronic device 300 is moving along in a downtown area, the accuracy may indicate that the determined coordinates are accurate to a few hundred meters. Additionally, the location engine 310 may also determine an altitude of the electronic device 300 in relation to sea level. In some instances, the coordinates may be part of a geographic coordinate system, and more particularly a common choice of coordinates may include latitude, longitude, and elevation. In particular, location engine 310 can be a Global Positioning System (GPS) engine. Accordingly, location engine 310 may provide location of the delivery agent 102 or 202 in the form of a latitude and longitude position of the electronic device 300 along with an accuracy value. As described previously, the application 110 may access this data generated by the location engine 310 and provide this data to the routing service 106.

In several examples, the electronic device 300 may also include sensors 312. The sensors 312 may include scanners, or have the capability of capturing images. In various examples, these sensors 312 may enable the electronic device 300 to gather capacity data 112(1) without prompting an operator of the delivery agent 102 or 202. For example, an operator of the delivery agent 102 or 202 may arrive at a location and scan a barcode on each package that is loaded on the delivery agent 102 or 202. In several examples, sensors 312 may be located directly on the delivery agent 102 or 202, in addition to or instead of on the electronic device 300. In these examples, the sensors may include weight sensors such that a remaining capacity may be assessed based on a detected weight of packages on the delivery agent 102 or 202.

The information collected by the sensors 312 may be sent as capacity data 112(1) that is assessed by the routing service 106 to determine a state of the delivery agent 102 or 202. For example, the routing service 106 may access a database containing information about the overall capacity of the delivery agent 102 or 202. The database may also contain information about how many packages are currently on the delivery agent 102 or 202. Using this information as well as the received capacity data 112(1), the routing service 106 may determine the remaining capacity of the delivery agent 102 or 202.

In addition, the electronic device 300 may include one or more memory(s) 304 that may constitute one or more computer-readable storage media. The one or more memory(s) 304 may include volatile and nonvolatile memory and/or removable and non-removable media implemented in any type of technology for storage of information, such as computer-readable instructions, data structures, program modules or other data. Such memory(s) 304 may include, but is not limited to, RAM, ROM, EEPROM, flash memory or other memory technology, CD-ROM, digital versatile disks (DVD) or other optical storage, magnetic cassettes, magnetic tape, solid state storage, magnetic disk storage, RAID storage systems, storage arrays, network attached storage, storage area networks, cloud storage, removable storage media, or any other medium that can be used to store the desired information and that can be accessed by a computing device. Depending on the configuration of the electronic device 300, the memory(s) 304 may be a type of tangible computer-readable storage media and may be a non-transitory storage media.

The memory(s) 304 may be used to store any number of functional components that are executable by the one or more processor(s) 302. In many implementations, these functional components comprise instructions or programs that are executable by the one or more processor(s) 302 and that, when executed, implement operational logic for performing the operations attributed herein to the electronic device 300. Functional components of the electronic device 300 may be executed on the one or more processor(s) 302 for implementing the various functions and features related to configuring the electronic device 300 to transmit state data 112 as disclosed herein may include application 110 and sensor module 314.

As discussed previously, application 110 may prompt an operator of a delivery agent 102 or 202 for capacity data 112(1) that is communicated to routing service 106. Additionally, application 110 may communicate location data 112(2). Additionally, application 110 may receive notifications, such as route data 122 from either the routing service 106 or a deciding entity regarding an updated route for the delivery agent 102 or 202. Additionally, in several examples, sensor module 314 may receive signals from sensors 312 and coordinate the transfer of data received from the sensors 312 to application 110 or directly to the routing service 106.

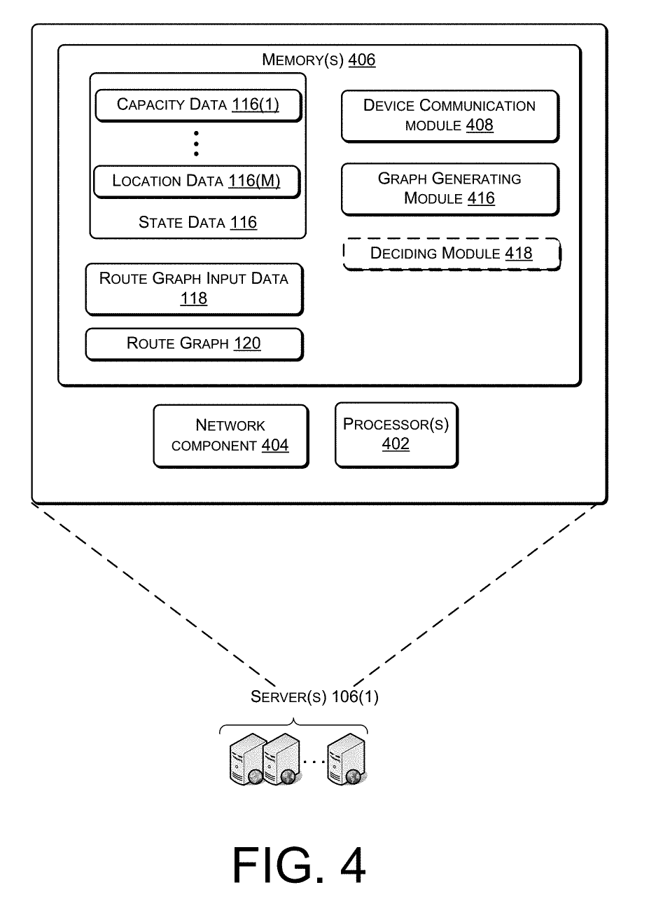

FIG. 4 illustrates a server 106(1) configured to operate the routing service 106. Although one set of servers 106(1) is illustrated in the routing service 106 described with regards to FIG. 1, multiple sets of servers may be used by different entities to collect state data 112 corresponding to multiple delivery agents and generate route graphs. Further, each set of servers may have one or multiple servers. For discussion purposes, the components described in FIG. 4 will be discussed as residing in a single server 106(1). The server 106(1) may include a number of components related to gathering state data 112. For example, the server 106(1) may include one or more processors, such as the representative processor 402. The processor 402 may include a hardware processing unit, such as a central processing unit, a graphics processing unit, or both. Additionally, the processor 402 may include a local memory that may store program modules, and/or program data. In an illustrative example, the processor 402 may include a cache memory and one or more registers as well as digital electronic circuits such as an arithmetic logic unit (ALU) and a control unit. The server 106(1) may also include input/output devices that may include one or more display devices, such as a liquid crystal display, a touch screen display, a display utilizing another type of display technology, or a combination thereof. The input/output devices may also include a keypad, a keyboard, a pointer device, one or more speakers, combinations thereof, and the like.

The server 106(1) also includes a network component 404 which implements network connectivity for the server 106(1). The network component 404 enables the server 106(1) to communicate with other devices where the communication is typically achieved by exchanging discrete data packets or frames over network signal lines such as twisted pair, coaxial, optical fiber, telephone lines, satellites, microwave, relays, modulated AC power lines, infrared wireless, or other conventionally known data transmission systems. In several examples, the network component 404 may also enable the server 106(1) to communicate over a wireless network such as a wireless local area network or a wireless wide area network.

Several examples of the server 106(1) may include one or more memory devices, such as memory 406. Memory 406 may include, but is not limited to, RAM, ROM, EEPROM, flash memory, one or more hard disks, solid state drives, optical memory (e.g., CD, DVD), or other non-transient memory technologies. In an example, at least a portion of the data stored by the memory 406 may be located remotely from the server 106(1) and be accessible by a number of computer devices of the server 106(1). In some cases, the memory 406 may be accessible by third parties.

As discussed previously, the memory 406 is utilized to store capacity data 116(1), location data 116(M), route graph input data 118, and route graphs 120. Additionally, the memory 406 may store one or more of the following modules: a device communication module 408, a graph generating module 416, and a deciding module 418.

In several examples, the device communication module 408 may receive data from the electronic device 300 corresponding to capacity data 116(1) and location data 116(M). In many cases, the device communication module 408 may communicate with the electronic device 300 via the network component 404. In various implementations, the device communication module 408 may send a push notification, such as route data 122, to electronic device 300 notifying an operator of the delivery agent 102 or 202 to take an updated delivery route that deviates from a current delivery route of the delivery agent 102 or 202.

In various examples, graph generating module 416 may generate the route graph 120 as also discussed previously with regards to FIG. 2. To generate the route graph, the graph generating module 416 may use capacity data 116(1), location data 116(M), and route graph input data 120 as inputs for the mechanisms to generate route graphs 120 as discussed previously. Based on the route graphs 120 being generated, the server 106(1) may use the device communication module 408 to send the route graphs 120 to a device of an associate. As discussed previously, the server 106(1) may send this data to a deciding entity such as an associate working with the routing service 106. In other examples, a deciding module 418 may assess the route graphs 120, based on several factors such as a degree of improved efficiency that may be realized by a particular route, a number of packages that may be picked up on a particular route, the scheduled arrival times for packages on a route, a priority level for various packages on a route, the type of packages included in a route, and/or additional travel distance associated with a route, and send one route graph to a device of an operator of the delivery agent 102 or 202, such as device 300.

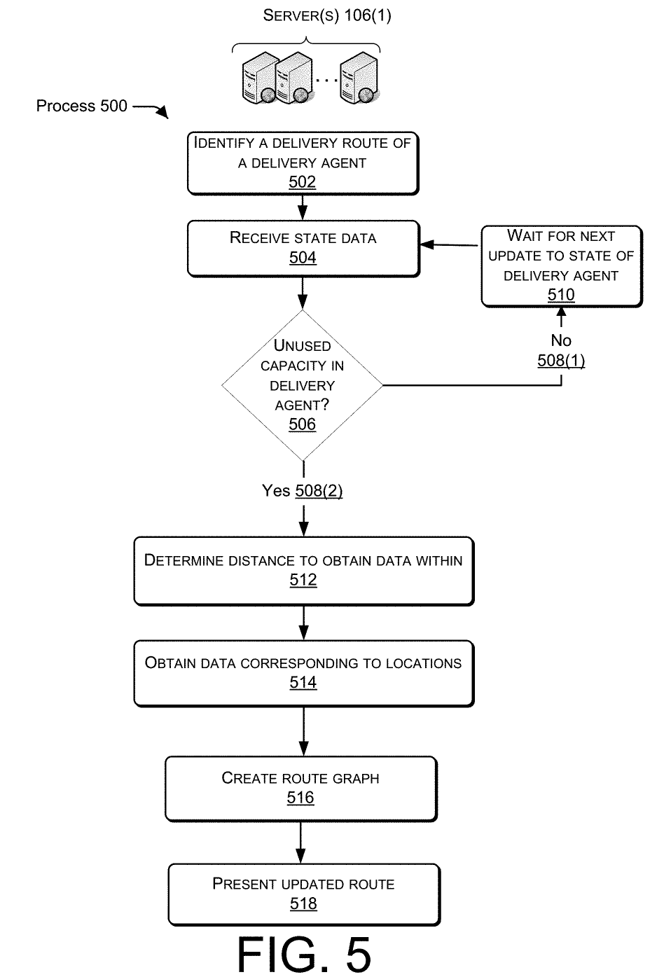

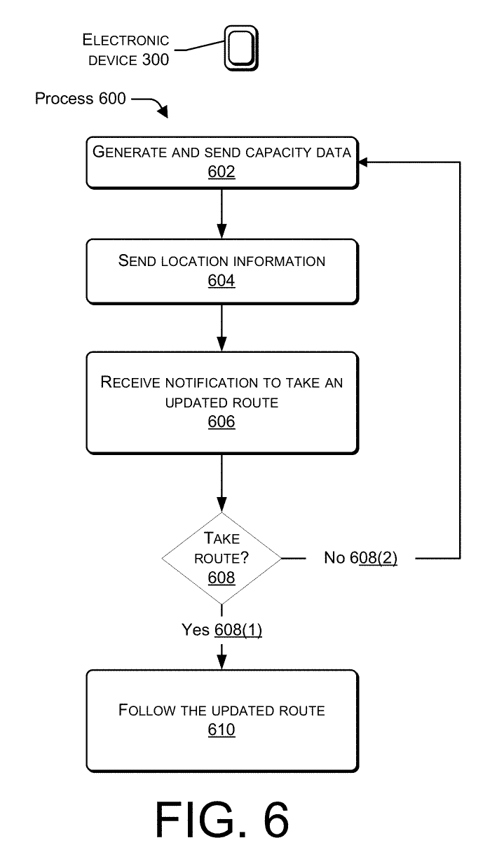

FIGS. 5 and 6 are flow diagrams illustrating example processes for re-routing a delivery agent to improve the efficiency of transporting packages. The processes are illustrated as a collection of blocks in a logical flow diagram, which represent a sequence of operations, some or all of which can be implemented in hardware, software or a combination thereof. In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described may not be construed as a limitation. Any number of the described blocks can be combined in any order and/or in parallel to implement the process, or alternative processes, and not all of the blocks have to be executed. For discussion purposes, the processes herein are described with reference to the frameworks, architectures and environments described in the examples herein, although the processes may be implemented in a wide variety of other frameworks, architectures or environments.

FIG. 5 illustrates a flow diagram of an example process 500 for re-routing a delivery agent to improve the efficiency of transporting packages. The process 500 may be performed in part by the server 106(1) of the routing service 106, which is similar to the server 106(1) as described previously.

At 502, the server 106(1) may identify a delivery route of a delivery agent, such as delivery agent 102 or 202. As discussed above, identifying a delivery route may include identifying locations on the delivery route including an origin location and a destination location. Identifying the delivery route may also include determining a scheduled time that the delivery agent 102 or 202 is scheduled to arrive at the destination location.

At 504, the server 106(1) may receive state data 112. As described previously, the state data 112 of a delivery agent 102 or 202 may comprise capacity data 112(1) and location data 112(2). The capacity data 112(1) comprises data corresponding to a current capacity of the delivery agent 102 or 202. As also discussed, location data 112(2) may indicate a location of the delivery agent 102 or 202. The server 106(1) may receive location data 112(2) at a time when the capacity data 112(1) is received or separately at a different time. In some examples, the location of the delivery agent 102 or 202 may be received periodically, in response to an event or while the delivery agent is traveling the delivery route, or based on some other criteria.

At 506, after receiving state data, the server 106(1) determines whether there is unused capacity in the delivery agent 102 or 202. At 506, the server 106(1) may also calculate an amount of unused capacity in the delivery agent 102 or 202. If the server 106(1) determines, based at least partly on the received state data, that there is no unused capacity in the delivery agent 102 or 202, the flow proceeds through branch 508(1) to 510 where the server 106(1) waits to receive an update to the state data.

Returning back to 506, if the server 106(1) determines that there is unused capacity in the delivery agent 102 or 202, the flow proceeds through branch 508(2) to 512. At 512, the server 106(1) may determine a distance within which to obtain data corresponding to facilities surrounding the delivery agent 102 or 202. As discussed previously, this distance may correspond to a distance that the delivery agent 102 or 202 may deviate in a particular direction away from a current route and arrive at a destination by a scheduled arrival time. This distance may be based on various parameters, such as the mode of transportation of the delivery agent 102 or 202, traffic patterns in the area, remaining capacity of the delivery agent 102 or 202, an expected arrival time of the delivery agent 102 or 202 at a destination, and the like. The area around the delivery agent 102 or 202 may include additional locations that the delivery agent 102 or 202 may travel to and still arrive at its destination location at or before the originally scheduled arrival time.

At 514, the server 106(1) may obtain data corresponding to locations located within a defined distance. As discussed above, the server 106(1) may query the facilities to obtain the data or obtain the data some other way. For example, the server 106(1) may receive requests to pick up containers from additional locations. The query may include requesting data from the locations corresponding to containers that may be ready to be shipped to the destination of delivery agent 102 or 202, or other locations on the current route of delivery agent 102 or 202.

At 516 the server 106(1) may create one or more route graphs 120. As discussed previously, the route graph 120 may contain suggestions for routes that the delivery agent 102 or 202 may take to pick up additional containers while traveling to its final destination. In various examples, as part of generating a suggestion for an additional route, the server 106(1) may initially identify that an item is available for pick up from a location not currently on the delivery route. The server 106(1) may also identify that this item needs to arrive at the destination location. The server 106(1) may calculate that the delivery agent 102 or 202 has the capacity for the item based, at least in part, on the capacity data and also calculate that the delivery agent 102 or 202 has time to pick up the item and still arrive at the destination by the scheduled arrival time. Using these calculations, the server 106(1) may include a route that includes picking up this item in the route graph 120. At 518, the server 106(1) may present the updated route graph 120 to a deciding entity. In several examples, the example process 500 may be repeated several times as the delivery agent 102 or 202 travels along the delivery route or any accepted, updated delivery route on the way to the final destination.

FIG. 6 illustrates a flow diagram of an example process 600 for interacting with the routing service 106. The process 600 may be performed in part by electronic device 300, which is similar to device 300 as described previously.

At 602, the electronic device 300 may generate and send capacity data. As described previously, the capacity data 112(1) may include information about the current capacity of the delivery agent 102 or 202. In various examples, an operator may provide this information after loading the delivery agent 102 or 202. In various examples, the capacity data 112(1) may be obtained automatically or semi-automatically via sensors present on the electronic device 300. For example, the electronic device 300 may include scanners that may scan packages that are loaded and unloaded on a delivery agent 102 or 202.

At 604, the electronic device 300 may send location data to the routing service 106. As described previously, this location data 112(2) may be sent periodically, in response to an event, or based on some other criteria as the delivery agent 102 or 202 travels along a delivery route. In several examples, this location data may be obtained by devices located on the delivery agent 102 or 202. For example, the delivery agent 102 or 202 may include a location engine or GPS device that sends location data to the routing service 106.

At 606, the electronic device 300 may receive a notification to take an updated route. As described previously, this updated route may direct the delivery agent 102 or 202 to pick up additional containers and may require the delivery agent 102 or 202 to deviate from its original delivery route. In other examples, the delivery agent 102 or 202 may stay on the original route but may make one or more additional stops along the way to pick up and/or drop off additional containers.

At 608, an operator of the delivery agent 102 or 202 may determine whether to take the updated route. If the operator decides not to take the updated route, the flow proceeds through branch 608(2) to 602 where additional capacity data is generated and sent. Otherwise, if the operator decides to take the updated route, the flow proceeds through branch 608(1) to 610 where the delivery agent 102 or 202 follows the updated route. As discussed above, the updated route allows the delivery agent 102 or 202 to make at least one additional stop to pick up or drop off one or more packages that otherwise would not have been picked up by the delivery agent 102 or 202. In several examples, the process 600 may be repeated several times as the delivery agent 102 or 202 travels along a route. The process 600 may be repeated several times as more updated routes are pushed to the delivery agent 102 or 202 as opportunities to pick up or drop off additional containers are determined.

Although the subject matter has been described in language specific to structural features, it is to be understood that the subject matter defined in the appended claims is not necessarily limited to the specific features described. Rather, the specific features are disclosed as illustrative forms of implementing the claims.

1. A method comprising:
identifying a first delivery route of a delivery agent, the first delivery route including an origin location and a destination location;
determining a scheduled time that the delivery agent is scheduled to arrive at the destination location;
receiving, from one or more sensors associated with the delivery agent, state data, the one or more sensors configured to detect the state data that includes capacity data associated with a current capacity of the delivery agent and location data indicating a location of the delivery agent;
identifying, during transit of the delivery agent on the first delivery route, that an item is available for pick up from an additional location for delivery to the destination location;
calculating that the delivery agent has capacity for the item based, at least in part, on the capacity data detected by the one or more sensors;
calculating that the delivery agent has time to pick up the item from the additional location and still arrive at the destination location by the scheduled time based, at least in part, on the location data detected by the one or more sensors; and
updating the first delivery route of the delivery agent to a second delivery route, the second delivery route including the additional location that has the item available for pick up.

2. The method of claim 1, wherein identifying that the item is available for pick up from the additional location comprises obtaining package data associated with the item from the additional location based, at least in part, on a determination that the additional location is within an area surrounding the location of the delivery agent.

3. The method of claim 2, wherein the determination that the additional location is within the area surrounding the location of the delivery agent comprises calculating a distance within which the delivery agent can deviate from the first delivery route and still arrive at the destination location by the scheduled time.

4. The method of claim 2, wherein the additional location is included in a graph of locations within the area, wherein different locations are added to the graph as the delivery agent traverses a delivery route.

5. The method of claim 1, wherein identifying that the item is available for pick up from the additional location comprises querying the additional location based, at least in part, on the state data indicating that the delivery agent has remaining capacity.

6. A computer-readable medium storing instructions that are executable by a processor to cause a computer to execute operations comprising:
receiving, from one or more sensors associated with a delivery agent that is en route to a destination, state data, the one or more sensors configured to detect the state data that indicates a capacity of the delivery agent;
determining that the delivery agent has remaining capacity based, at least in part, on the state data detected by the one or more sensors;
identifying that an item is available for pick up from an additional location for delivery to the destination;
updating a delivery route of the delivery agent to include the additional location based, at least in part, on a location of the delivery agent and a time that the delivery agent is scheduled to be at the destination; and
providing a notification of the updated delivery route to the delivery agent.

7. The computer readable medium of claim 6, wherein the state data further comprises location data corresponding to a current location of the delivery agent.

8. The computer-readable medium of claim 6, wherein the state data indicates a current capacity of the delivery agent.

9. The computer-readable medium of claim 6, the operations further comprising determining an area within which the delivery agent has time to travel and still arrive at the destination at the time that the delivery agent is scheduled to be at the destination, wherein the additional location is within the area.

10. The computer-readable medium of claim 9, wherein identifying that the item is available for pick up from the additional location comprises obtaining data from the additional location based, at least in part, on a determination that the additional location is within the area.

11. The computer-readable medium of claim 9, wherein a size of the area changes based, at least in part, on a location of the delivery agent and a remaining amount of time until the time that the delivery agent is scheduled to be at the destination.

12. The computer-readable medium of claim 6, the operations further comprising:
calculating that the delivery agent has capacity for the item based, at least in part, on the state data; and
calculating that the delivery agent has time to pick up the item and still arrive at the destination at the time that the delivery agent is scheduled to be at the destination.

13. The computer-readable medium of claim 6, the operations further comprising:
generating a graph comprising individual locations within an area surrounding the delivery agent; and
obtaining package data associated with items from at least a portion of the individual locations, wherein identifying that the item is available for pick up from the additional location for delivery to the destination is based, at least in part, on the package data associated with the item, wherein one location of the individual locations comprises the additional location.

14. The computer readable medium of claim 13, wherein the area encompasses an area within which the delivery agent can travel away from the delivery route and still arrive at the destination by the time that the delivery agent is scheduled to be at the destination.

15. A computing device comprising:
a processor; and
a memory coupled to the processor, the memory storing computer-readable instructions that are executable by the processor to cause the computing device to execute operations comprising:
obtaining, by one or more sensors associated with a delivery agent, capacity data associated with a capacity of the delivery agent, the one or more delivery agent sensors configured to detect data associated with the delivery agent;
obtaining, by the one or more sensors, location data associated with a location of the delivery agent;
sending the capacity data and the location data to a remote computer; and
after the delivery agent has left an origin location, receiving, from the remote computer, a notification to re-route the delivery agent from an original route, the original route including the origin location, a destination location and a scheduled time that the delivery agent is scheduled to arrive at the destination location, wherein the re-route instructs the delivery agent to traverse a different route and still arrive at the destination location by the scheduled time.

16. The computing device of claim 15, wherein obtaining the capacity data comprises receiving data corresponding to the capacity of the delivery agent via a user interface in response to a query.

17. The computing device of claim 15, wherein the capacity data indicates a quantity of additional items that may be loaded on the delivery agent.

18. The computing device of claim 15, wherein the capacity data indicates a quantity of containers loaded on the delivery agent and a size of the delivery agent.

19. The computing device of claim 15, the memory storing additional computer-readable instructions that are executable by the processor to cause the computing device to execute operations comprising sending a location of the delivery agent in response to at least one of sending the capacity data, or an expiration of a period of time.

20. The computing device of claim 15, wherein the delivery agent comprises at least one of a truck, a car, a bike, or an individual on foot.
